(19) United States
(12) Patent Application Publication
(10) Pub. No.: US 2019/0212890 A1
(43) Pub. Date: Jul. 11, 2019

(54) METHOD AND SYSTEM FOR PRESENTING A QUESTIONNAIRE

(71) Applicant: National Taiwan Normal University, Taipei City (TW)

(72) Inventors: Jon-Chao HONG, Taipei City (TW); Chi-Ruei TSAI, Taipei City (TW); Hsien-Sheng HSIAO, Taipei City (TW)

(73) Assignee: National Taiwan Normal University, Taipei City (TW)

(21) Appl. No.: 16/028,811

(22) Filed: Jul. 6, 2018

(30) Foreign Application Priority Data
Jan. 9, 2018 (TW) 107100752

(51) Int. Cl. G06F 3/0486; G06F 3/0481; G06Q 30/02

(52) U.S. Cl. CPC G06F 3/0486; G06Q 30/0282; G06Q 30/0203; G06F 3/04817

(57) ABSTRACT

A method for displaying a questionnaire includes steps of receiving base data constituting the questionnaire; displaying the questionnaire that includes a plurality of response icons each corresponding to a shared response option, and a plurality of question icons each corresponding with a question; instructing a user to answer the questionnaire; and in response to receipt of an answering gesture indicating association of one of the question icons and one of the response icons, recording one entry of answer log that indicates the user's answer to one of the questions corresponding with the selected one of the question icons being one of the shared response options corresponding with the selected one of the response icons.

### CROSS-REFERENCE TO RELATED APPLICATION

This application claims priority of Taiwanese Patent Application No. 107100752, filed on Jan. 9, 2018.

### FIELD

The disclosure relates to a method and a system for presenting a questionnaire.

### BACKGROUND

A conventional questionnaire typically includes a number of questions/statements, each accompanied by a plurality of response options (e.g., strongly agree, agree, neutral, disagree, strongly disagree, etc.).

A conventional examination paper typically includes a number of multiple choice questions or multiple selection questions, each accompanied by a plurality of possible choices/selections (e.g., selections A, B, C, etc.).

It is noted that in some cases, the response options and the possible choices/selections maybe common among the questions/statements. For example, one particular set of response options may be used in two or more questions included in the convention questionnaire.

### SUMMARY

One object of the disclosure is to provide a method for presenting a questionnaire.

According to one embodiment of the disclosure, the method is implemented using a processor of an electronic device and includes:

receiving base data constituting the questionnaire, the base data including a plurality of questions, and a plurality of distinct shared response options which are shared by the questions, wherein for each of the questions, one of the shared response options is to be selected as an answer to the question;

displaying the questionnaire in the form of a graphic interface on a display of the electronic device, the graphic interface including a plurality of distinct response icons each corresponding to a respective one of the shared response options, a question zone, and a plurality of question icons contained in the question zone, each of the question icons corresponding with a respective one of the questions;

constructing an answer log, and instructing a user to answer the questionnaire; and

in response to receipt of an answering gesture indicating association of a selected one of the question icons and a selected one of the response icons, recording one entry of the answer log that indicates the user' s answer to one of the questions corresponding with the selected one of the question icons being one of the shared response options corresponding with the selected one of the response icons.

### BRIEF DESCRIPTION OF THE DRAWINGS

Other features and advantages of the disclosure will become apparent in the following detailed description of the embodiments with reference to the accompanying drawings, of which:

FIG. 1 is a block diagram of a system for presenting a questionnaire according to one embodiment of the disclosure.

FIG. 2 is a flow chart illustrating steps of a method for presenting a questionnaire according to one embodiment of the disclosure.

FIG. 3 illustrates an exemplary graphic interface displaying a questionnaire;

FIG. 4 illustrates an answering gesture being performed for answering one question included in the questionnaire; and

FIGS. 5 and 6 illustrate exemplary ways to refresh display of the questionnaire in response to one question being answered.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

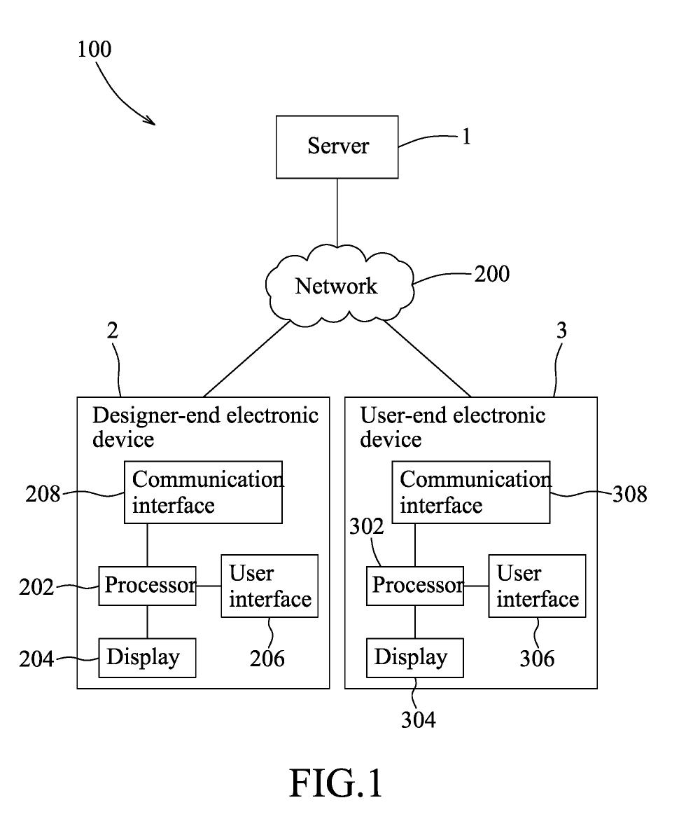

FIG. 1 is a block diagram of a system 100 for presenting a questionnaire according to one embodiment of the disclosure. The system 100 includes a server 1, a designer-end electronic device 2, and a user-end electronic device 3.

The designer-end electronic device 2 maybe embodied using a personal computer (PC), a laptop, a tablet, a mobile device (e.g., a smartphone, a personal digital assistant (PDA)), etc., and is able to communicate with the server 1 over a network 200 (e.g., the Internet).

The designer-end electronic device 2 includes a processor 202, a display 204, a user interface 206, and a communication unit 208.

The processor 202 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc.

The user interface 206 enables a user to interact with the designer-end electronic device 2, and may be embodied using a keyboard/mouse, a writing pad, etc., or be integrated with the display 204 as a touchscreen.

The communicating unit 208 may include a short-range wireless communicating module supporting a short-range wireless communication network using a wireless technology of Bluetooth® and/or Wi-Fi, etc., and a mobile communicating module supporting telecommunication using Long-Term Evolution (LTE), the third generation (3G) and/or fourth generation (4G) of wireless mobile telecommunications technology, and/or the like.

The user-end electronic device 3 includes a processor 302, a display 304, a user interface 306, and a communication unit 308. Similar to the designer-end electronic device 2, the user-end electronic device 3 maybe embodied using a personal computer (PC), a laptop, a tablet, a mobile device (e.g., a smartphone, a personal digital assistant (PDA)), etc., and is able to communicate with the server 1 over a network 200 (e.g., the Internet).The processor 302 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc.

The user interface 306 enables a user to interact with the user-end electronic device 3, and may be embodied using a keyboard/mouse, a writing pad, etc., or be integrated with the display 304 as a touchscreen.

The communicating unit 308 may include a short-range wireless communicating module supporting a short-range wireless communication network using a wireless technology of Bluetooth® and/or Wi-Fi, etc., and a mobile communicating module supporting telecommunication using Long-Term Evolution (LTE), the third generation (3G) and/or fourth generation (4G) of wireless mobile telecommunications technology, and/or the like.

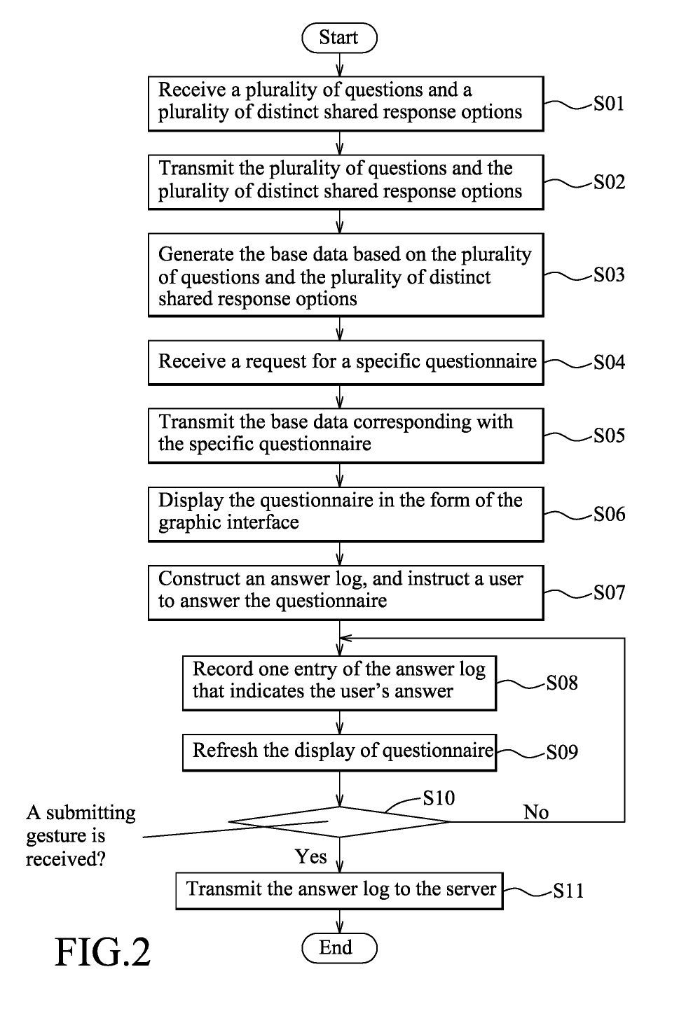

FIG. 2 is a flow chart illustrating steps of a method for presenting a questionnaire according to one embodiment of the disclosure.

In step S01, the designer-end electronic device 2 receives a plurality of questions and a plurality of distinct shared response options that serve as base data to constitute the questionnaire. Specifically, a user of the designer-end electronic device 2 (hereinafter referred to as a designer) may operate the user interface 206 to input the base data. In this embodiment, the plurality of distinct shared response options are shared by and common to the questions. For each of the questions, one of the distinct shared response options is to be selected as an answer (or a “choice”) to the question.

In one example, the questionnaire is associated with restaurant customer satisfaction. As such, the questions may concern various aspects of the restaurant, such as “Quality of Food”, “Service”, “Cleanliness”, “Facilities”, etc. The response options may include, for example, “Very poor”, “Poor”, “Mediocre”, “Good”, “Very good”, etc.

In step S02, the processor 202 of the designer-end electronic device 2 controls the communication unit 208 to transmit the plurality of questions and the plurality of distinct shared response options to the server 1.

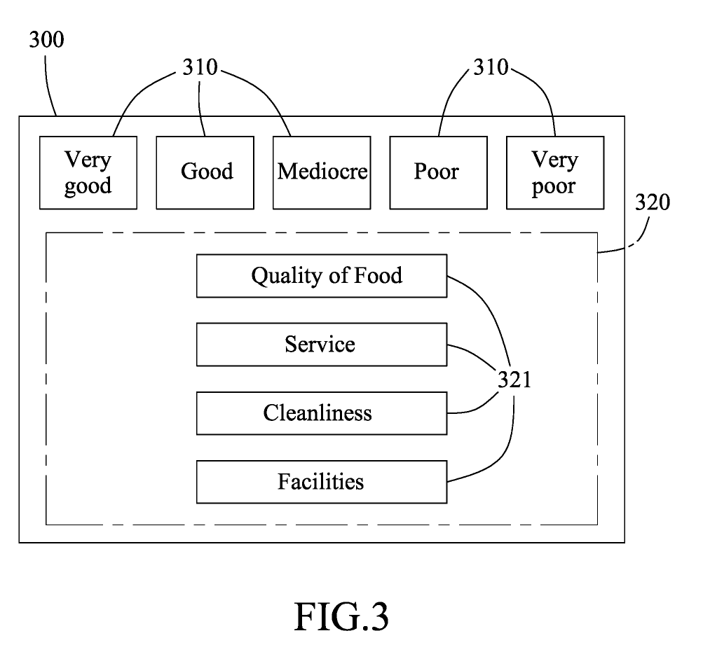

In step S03, the server 1 generates the base data based on the plurality of questions and the plurality of distinct shared response options, and stores the base data in a storage component thereof. In this embodiment, the base data enables an electronic device to display the questionnaire in the form of a graphic interface. In one example as shown in FIG. 3, a graphic interface 300 may include a plurality of distinct response icons 310 each corresponding to a respective one of the shared response options, a question zone 320, and a plurality of question icons 321 contained in the question zone 320. Each of the question icons 321 corresponds with a respective one of the questions.

It is noted that the operations of steps S01 to S03 may be repeated multiple times, and as a result, the server 1 may store ba se data for multiple questionnaires.

In step SO4, the server 1 receives a request for a specific questionnaire from the user-end electronic device 3. In use, this may be done by an application installed in the user-end electronic device 3 and executed by the processor 302 of the user-end electronic device 3. When it is determined that the specific questionnaire is to be presented, the processor 302 controls the communication unit 308 to transmit the request to the server 1.

In response, the server 1 transmits the base data corresponding with the specific questionnaire to the user-end electronic device 3 in step S05.

In step S06, the processor 302 controls the display 304 to display thereon the questionnaire in the form of the graphic interface, as shown in FIG. 3. It is worth noting that in this embodiment, each of the response icons 310, which represents a specific response option, is displayed on the display 304 only once (i.e., only one set of the response icons 310 is displayed on the display 304, and duplicates thereof are not provided to be designated each to a respective one of the questions).

In step S07, the processor 302 constructs an answer log, and generates an instruction for a user to answer the questionnaire (e.g., displaying a text or an audio output).

In response, the user may operate the user-end electronic device 3 to answer the questionnaire. In this embodiment, the answering of the questionnaire displayed as a graphic interface maybe done by the user performing an answering gesture. Specifically, the answering gesture may be a drag and drop gesture, and indicates association of a selected one of the question icons and a selected one of the response icons (thereby indicating the user has answered one of the questions using the associated one of the response options).

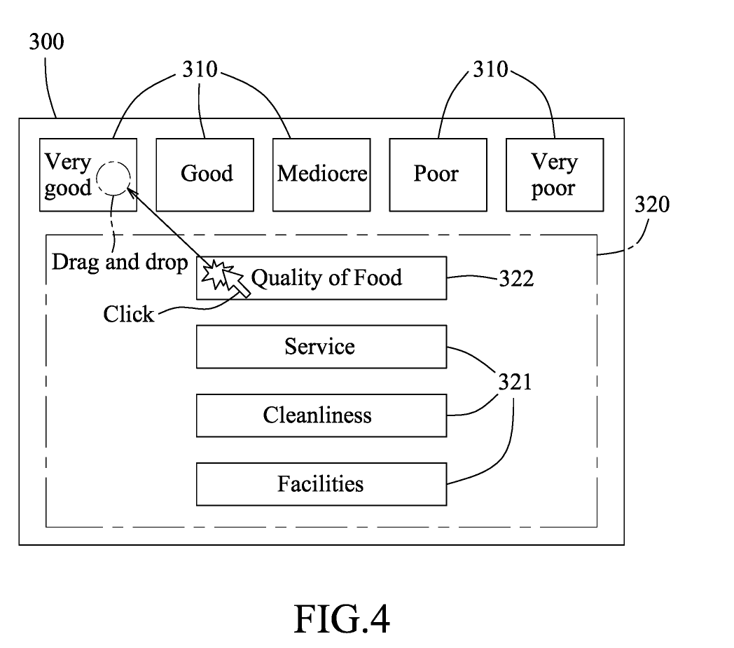

Referring to FIG. 4, in an example where the user-end electronic device 3 is embodied using a smartphone, the user may first perform a long-press gesture on one of the question icons 321 (e.g., the “Quality of food” icon) in order to select the one of the question icons 321. Then, the user may hold the selected one of the question icons 321, drag the selected one of the question icons 321 onto one of the response icons 310 (e.g., the “Very good” icon), and release the hold on the selected one of the question icons 321 so as to associate the response option corresponding with the one of the response icons 310 (i.e., Very good) to the question corresponding with the selected one of the question icons 321, (i.e., Quality of food).

In step S08, in response to the receipt of the answering gesture, the processor 302 records one entry of the answer log that indicates the user's answer to one of the questions corresponding with the selected one of the question icons being one of the shared response options corresponding with the selected one of the response icons.

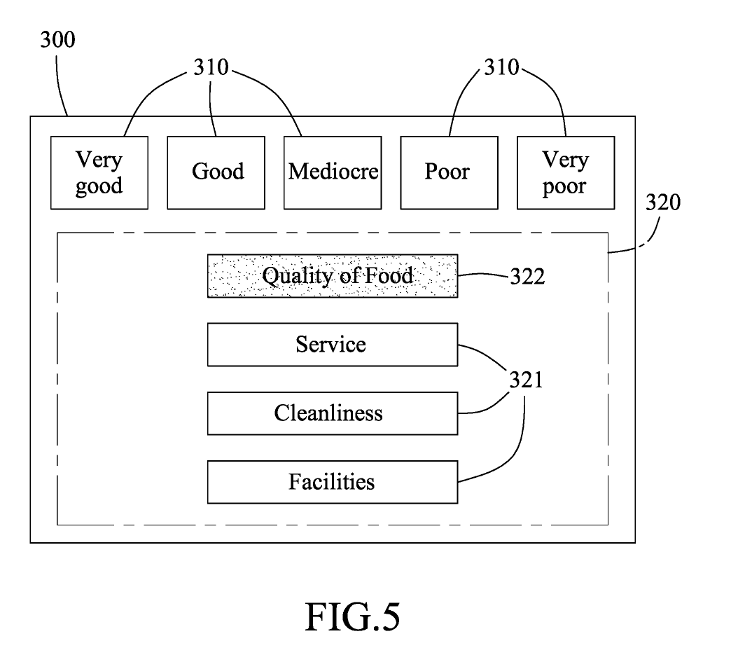

In addition to the operations in step S08, in step S09, the processor 302 refreshes the display of questionnaire in such a manner that an appearance of the selected one of the question icons 321 is changed. In one embodiment as illustrated in FIG. 5, a color of the selected one of the question icons 322 is changed.

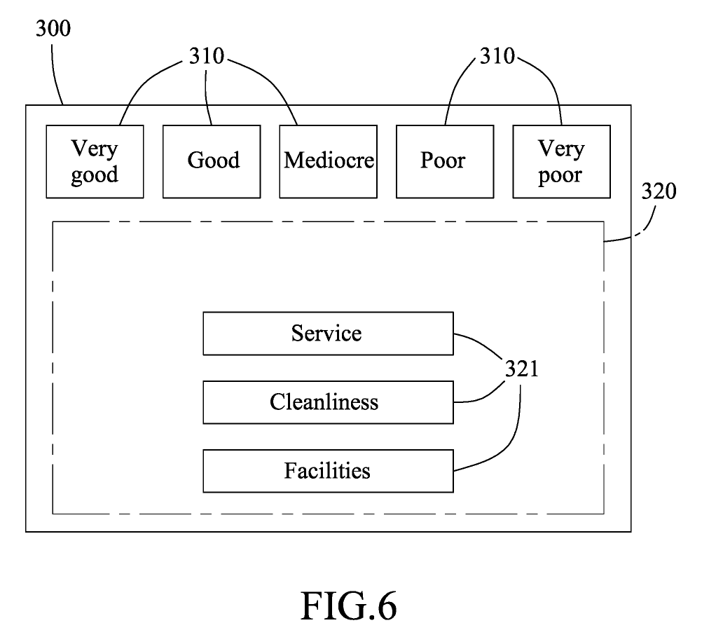

In an alternative embodiment shown in FIG. 6, the processor 302 refreshes display of the questionnaire in such a manner that the selected one of the question icons disappears from the question zone 320 of the graphic interface 300.

Then, in step S10, the processor 302 determines whether a submitting gesture indicating that the user has finished answering the questionnaire is received. In use, the submitting gesture may be in the form of clicking of a specific button (not shown) on the graphic interface 300 or a pre-defined gesture that can be performed by the user.

When it is determined that the submitting gesture is not received, the flow goes back to step S08 for allowing the user to answer other questions. As a result, the processor 302 may receive more answering gestures, and in turn record entries of the answer log for the remaining question(s).

On the other hand, when it is determined that the submitting gesture is received, the flow proceeds to step S11, in which the processor 302 transmits the answer log to the server 1. Alternatively, when it is determined that all of the questions included in the questionnaire have been answered, the flow may directly proceed to step S11 without receiving the submitting gesture.

It is noted that while the above embodiments are directed to presentation of a questionnaire, in other embodiments, other similar forms of data, such as a test paper that includes multiple choice questions, may be presented by employing the above method.

To sum up, the embodiments of the disclosure provide a method for presenting the questionnaire in a way that, since each of the plurality of response icons is displayed only once, an overall space needed for displaying the entire questionnaire may be reduced. This method may be particularly useful in cases where the user-end electronic device 3 has a relatively small display, such as a smartphone. In those cases, a larger number of questions may be simultaneously displayed on the display 304 without having to scroll up and down.

In the description above, for the purposes of explanation, numerous specific details have been set forth in order to provide a thorough understanding of the embodiment(s). It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiment, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for displaying a questionnaire, to be implemented using a processor of an electronic device and comprising:
receiving ba se data constituting the questionnaire, the base data including a plurality of questions, and a plurality of distinct shared response options which are shared by the questions, wherein for each of the questions, one of the shared response options is to be selected as an answer to the question;
displaying the questionnaire in the form of a graphic interface on a display of the electronic device, the graphic interface including a plurality of distinct response icons each corresponding to a respective one of the shared response options, a question zone, and a plurality of question icons contained in the question zone, each of the question icons corresponding with a respective one of the questions;
constructing an answer log, and instructing a user to answer the questionnaire; and
in response to receipt of an answering gesture indicating association of a selected one of the question icons and a selected one of the response icons, recording one entry of the answer log that indicates the user's answer to one of the questions corresponding with the selected one of the question icons being one of the shared response options corresponding with the selected one of the response icons.

2. The method of claim 1, wherein the answering gesture is a drag and drop gesture.

3. The method of claim 1, wherein, in response to receipt of the answering gesture, the processor further refreshes display of the questionnaire in such a manner that an appearance of the selected one of the question icons is changed.

4. The method of claim 1, wherein, in response to receipt of the answering gesture, the processor further refreshes display of the questionnaire in such a manner that the selected one of the question icons disappears from the question zone of the graphic interface.

5. The method of claim 1, wherein the base data is received from a server that communicates with the electronic device over a network.

6. The method of claim 1, wherein:
the step of recording one entry of the answer log is repeated for each of the questions; and
after it is determined that all of the questions included in the questionnaire has been answered, transmitting the answer log to a server.

7. The method of claim 1, further comprising:
in response to a submitting gesture, transmitting the answer log to a server.

8. The method of claim 1, wherein, in displaying the questionnaire on the display of the electronic device, each of the plurality of response icons is displayed only once.
